(19) United States
(12) Patent Application Publication
(10) Pub. No.: US 2023/0004919 A1
(43) Pub. Date: Jan. 5, 2023

(54) METHOD FOR DATA-DRIVEN DYNAMIC EXPERTISE MAPPING AND RANKING

(71) Applicants: Ponarul AMMAIYAPPAN PALANISAMY, Madurai (IN); Chitra RAJAKUBERAN, Chennai (IN)

(72) Inventors: Ponarul AMMAIYAPPAN PALANISAMY, Madurai (IN); Chitra RAJAKUBERAN, Chennai (IN)

(21) Appl. No.: 17/781,986

(22) PCT Filed: Dec. 3, 2020
(86) PCT No.: PCT/IN2020/051000

§ 371 Date: Jun. 2, 2022

(30) Foreign Application Priority Data
Dec. 5, 2019 (IN) 201941050205

(51) Int. Cl. G06Q 10/06; G06Q 10/10

(52) U.S. Cl. CPC G06Q 10/063112; G06Q 10/1053

(57) ABSTRACT

The present invention relates to a methodology that enables mapping and ranking of expertise based on crowdsourced data using Big Data algorithms and Bayesian probability. The methodology involves a group of nodes corresponding to the showcased expertise of an entity, with the level of expertise being determined by an unique dynamic numerical value for each node termed, “Expertise Quotient”, which is based on the ratings on various attributes crowdsourced from peers with similar expertise as well as reference ratings from professionals in the same domain and the top experts in any domain may be identified based on the Expertise Quotient.

### FIELD OF THE INVENTION

The present invention relates to information retrieval and processing method. Specifically, the invention relates to the gathering of data related to the expertise of each entity as well as the methodology involved in the quantification and ranking of expertise.

### BACKGROUND OF THE INVENTION

In spite of the large amount of data available to map expertise and identify experts in any industry, the existing systems suffer from several drawbacks such as the lack of quantitative methods for evaluating expertise. In addition, the current expertise mapping models are exclusively based on academic qualifications and professional affiliations, which results in the exclusion of professionals with useful knowledge. Furthermore, in most of the conventional approaches the expertise are self-reported by the professionals and authentication of these expertise depend on endorsements received from people, who may often times be from different industries or may not even know the professionals whom they are endorsing, resulting in the exaggeration of the breadth of expertise, there by skewing the expertise map.

### SUMMARY

The present invention specifically relates to a method for data-driven mapping and ranking of expertise. Expertise mapping comprises validation of expertise of each user and ranking their expertise in a selected domain or industry based on the generation of a numerical value termed “Expertise Quotient” through crowdsourcing, Bayesian statistics and Big data algorithms.

By focusing on quantifying tacit knowledge and credibility through reliable crowdsourcing approaches, this methodology is a significant improvement on existing expertise-ranking models. Furthermore, in the methodology presented here, since the Expertise Quotient of the users are based on the review ratings crowdsourced from peers of similar expertise as well as the references gathered from peers as well as beneficiaries of expertise from the same domain, a highly accurate data-driven dynamic expertise map is generated.

### BRIEF DESCRIPTION OF THE DRAWINGS

FIG. 1 is a block diagram depicting the various functional modules of an expertise network system, according to some embodiments.

FIG. 2 is a diagram depicting the link between entities and the validated expertise in an expertise network system, as per some embodiments.

FIG. 3 is a data diagram depicting the identification of top experts in an area of expertise based on Expertise Quotient, as per some embodiments.

FIG. 4 is a functional diagram illustrating the machine architecture as well as machine-readable medium, according to some embodiments.

Referring to the drawings, the embodiments of the present invention are further described. The figures are not necessarily drawn to scale and in some instances the drawings have been exaggerated or simplified for illustrative purposes only.

### DETAILED DESCRIPTION OF THE INVENTION

A detailed description of the methodology is included herein is provided for a detailed understanding and are not meant to restrict the scope of the embodiments. The claimed methodology may also be embodied in other ways, in conjunction with present or future technologies.

With respect to the present invention, the term “expertise network system” is meant to encompass an authenticated virtual expertise profile for entities that depict their levels of expertise in their niche areas, authority in the field as well as credibility, as perceived by peers and beneficiaries of knowledge. The entities may be professionals from any industry and from any expertise level. The expertise and credibility of the entity is indicated by a numerical value called the “Expertise Quotient”, which is generated using Bayesian statistics and Big data algorithms.

An example embodiment provides various practical applications. For example, the embodiment may be utilized by businesses to identify top experts in an industry, which will enable them to find solutions to problems, identify strategies for future growth and find influencers who can evangelize or promote their products, solutions, technology or brands. Other related applications include utilization by head hunters or Human Resource (HR) Managers to identify and verify professionals suitable for specific opportunities based on their expertise as well as professional credibility.

### Expertise Network System

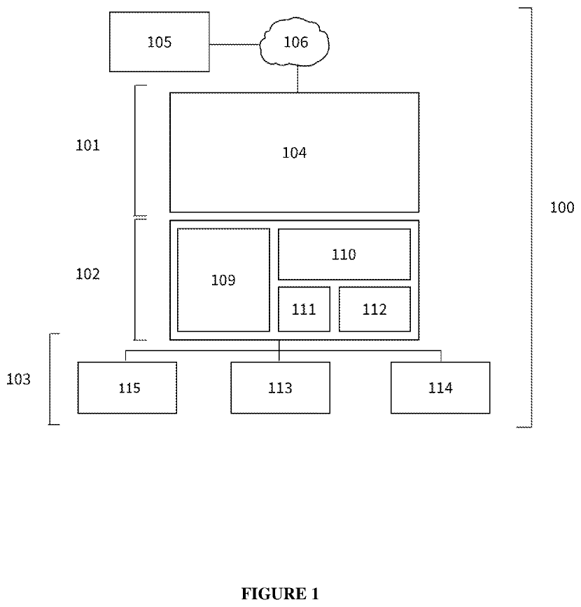

As depicted in FIG. 1, the expertise network system 100 comprises of 3 modules: 1) front-end layer 101, 2) application layer 102, 3) data layer 103. The front-end layer of the expertise network system comprises an interface module 104 that receives requests from computing devices 105 over a network or even a cloud computing network 106. The application layer of the expertise network system includes the application server modules 112 that are essential for implementing the functionality associated with the expertise network system and includes the Expertise Quotient generation module 109, review module 110 and showcase module 111. The data layer includes several databases, including those for storing profile data 112, user activity 113 and expertise data 115.

### Expertise Validation

In the present invention, a numerical value termed the Expertise Quotient based on probability interpretations is generated for each entity, which represents the expertise as well as professional credibility of the entity for each of the expertise validated and may be made available to other entities of the expertise network system.

Expertise Quotient is calculated using Bayesian theorem

E=[(v÷(v+m))×R]+[(m÷(v+m))×C]

where,

E is the Expertise Quotient corresponding to the plurality of nodes;

R is the average of all the ratings received for that expertise, including the review ratings, reference ratings and impact ratings;

v is the total number of ratings for that expertise, including the review ratings, reference ratings and impact ratings;

m is the minimum number of ratings required per expertise, which is a constant; and

C is the mean value of all the ratings for that expertise, including the review ratings, reference ratings and impact ratings.

The Expertise Quotient so generated may be used to further rank the members so as to represent the level of expertise of the entity in any specific industry.

The entity who may also be referred to as “member” or “user”, may showcase expertise on a web-based platform or application in audio/video/textual formats to specific topics in their area of expertise or niche. The topics may be chosen by experts or influencers in the relevant areas of expertise and the entity showcases his or her tacit knowledge on the topic by challenging or supporting the perspectives, opinions or insights of the specific expert or influencer. The showcased expertise is rated by peers of similar expertise, with a maximum deviation of +/−10%, in a dynamic double-blind peer-review process. The ratings crowdsourced from the peers for the different attributes of expertise as well as credibility are averaged and multiplied with his/her current Expertise Quotient for that specific expertise, thereby making it further dynamic.

The entity may invite peers from the same niche who know him or her professionally to provide references for an expertise. The resultant ratings, which can be over various attributes of expertise as well as credibility then are averaged and multiplied with the referee's current Expertise Quotient for that specific expertise, making it highly dynamic.

In addition, the entity may also invite beneficiaries of expertise, such as clients, mentees and colleagues to provide references for an expertise. In this case, the ratings, termed as impact ratings are obtained by averaging the ratings from the beneficiary who has rated the entity for the specific expertise and multiplying it with a constant, the impact constant and the beneficiary's current Expertise Quotient for that specific expertise. The beneficiary's ratings are given additional importance here as these people have been directly impacted by the entity's expertise and as such their ratings should give a better understanding of the entity's expertise in that specific domain.

If the referee/beneficiary has not validated his or her expertise for that specific expertise, they will not be able to provide ratings. In this case, they will have to showcase their expertise first in order to unlock the ability to provide rating.

An expertise may be considered to be validated, only when: 1) the entity has successfully showcased his or her expertise on at least one of the topics under a specific expertise, 2) the showcased expertise has been successfully reviewed by his or her peers and 3) the entity has received at least one reference for that expertise from his or her peers or beneficiaries of expertise.

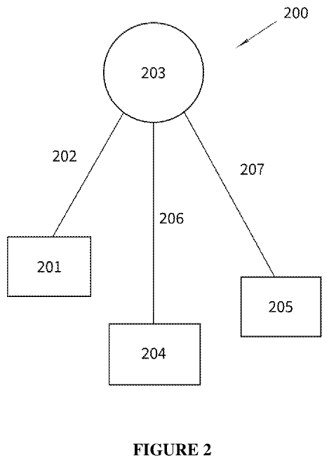

The different expertise that have been validated 201 by an entity 203 form the nodes with the Expertise Quotient generated 202 being the edge, as conceptualized in FIG. 2. As shown in the figure, each expertise that has been validated is represented by a specific node—201, 204, and 205 with the Expertise Quotient for the specific nodes being represented by 202, 206 and 207 respectively.

Expertise Quotient represents the level of expertise of the entity for a specific niche area and thereby acts as a virtual portfolio that showcases their professional thought leadership. Since Expertise Quotient focuses more on the implicit or tacit knowledge, which is based on the expertise that the entity has accumulated throughout his or her career through observations and experiences as well as professional credibility, it supersedes their resume.

### Expertise Quotient Generation

In an example embodiment, a system for generating Expertise Quotient may be defined using crowdsourcing techniques. Once defined, the data collected using these techniques are provided to the Expertise Quotient generation module. A few examples of the data that may be collected using crowdsourcing techniques include: 1) The expertise showcased by an entity is rated by gathering reviews from peers of similar expertise on different expertise attributes in a dynamic double-blind peer-review process, 2) The entity's professional credibility is rated by gathering references from peers from the same niche who know the entity as well as from beneficiaries of their expertise.

In order to increase user engagement, high-quality showcase for each expertise may be rewarded based on their Expertise Quotient. For example, the top 1 percentile of any expertise may be marked with a Gold badge to denote the high-quality as well as the high ratings received from the peers and referees.

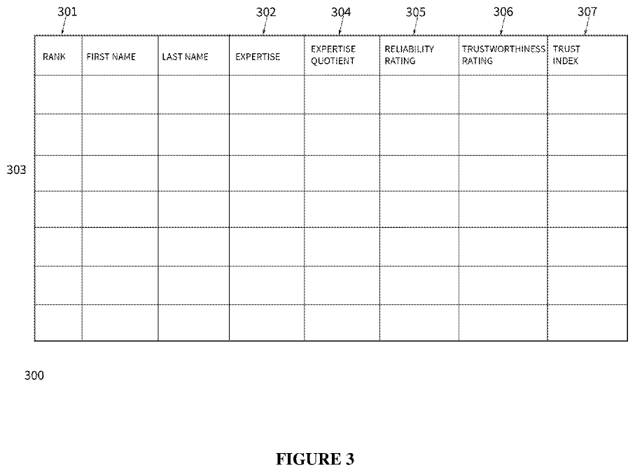

Based on the Expertise Quotient generated 304 for each of the expertise 302, a percentile ranking 301 table 300 can be generated for all the entities who have validated the specific expertise. As depicted in FIG. 3, this enables businesses to identify top experts 303 in any area of expertise, which will further enable them to find innovative solutions to any critical problems they may be facing, identify growth strategies as well as find influencers who may potentially promote their products, solutions, technology or brands.

In order to ensure the fidelity of the peer-review and reference processes, the concept of reliability rating 305, trustworthiness rating 306 and Trust Index 307 have been introduced, wherein the variance of the ratings provided by each entity is compared against the average ratings provided so far. Reliability rating is defined as the variance of the average of the review ratings provided for a showcased expertise, while trust worthiness rating is the variance of the average of the reference ratings provided for an entity and Trust Index is the average of the reliability and trustworthiness ratings of a specific entity. The Trust Index indicates the dependability and thereby, the thought leadership of a specific entity.

### Example Uses for the Expertise Quotient

In one example embodiment, a verified organization can access the Expertise Quotient of its employees exclusively upon their consent, which enables it to identify prevalent expertise gaps and post related opportunities to identify the best candidates with the right expertise. In another example, few embodiments empower Human Resources (HR) Technology by: a) improving the expertise-based profiling, which results in the identification of suitable talent for opportunities within the organization and verification of their expertise as well as professional credibility prior to hiring and b) providing robust metrics, which helps in the identification of expertise gaps as well as potential unused expertise within the organization.

In an example embodiment, businesses can seek verified professionals with validated expertise, to find solutions to problems, identify strategies for future growth and discern influencers who can evangelize or promote their products, solutions, technology or brands. The professionals can avail of these opportunities to monetize their expertise in a knowledge economy, based on their Expertise Quotient.

### Example Machine Architecture and Machine-readable Medium

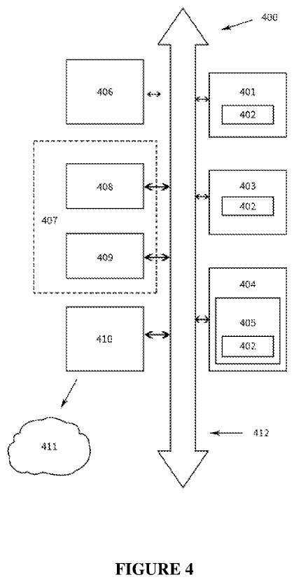

FIG. 4 is a functional diagram illustrates a programmed computer system for generating Expertise Quotient in accordance with some embodiments. The machine-readable medium 405 that is housed within the drive unit 404 stores, encodes as well as executes the instructions 402 and enables local computing devices 400 such as computer system, desktop computer, laptop computer, mobile device, personal digital assistant (PDA) or cellular telephone to perform one or more of the methodologies discussed herein. The machine-readable medium may be a centralized or distributed database that includes the network interface 410 over which the instructions may be further transmitted over a network 411.

The local computing devices typically includes a processing unit 401, which may also be referred to as the central processing unit (CPU), which utilizes the instructions retrieved from memory 403 to control the input data from user interface devices 407 such as Keyboard 408, Graphic interactive devices 409, as well as the output data that is displayed on the display devices such as display monitor 406. The network interface 411 enables the processor to be linked to the cloud, a network, or another computer, which helps in the sharing of processing burden.

The Processor and Memory units are linked bi directionally and may include a suitable non-transitory computer readable storage media such as magnetic media, optical media, magneto-optical media, specially configured hardware devices, ROM and RAM devices. As shown, the different sub systems in a local computing device are connected by bus 412.

The embodiments described in the present disclosure may be applied in the context of computer-executable instructions or in another instance, may be carried out in a distributed computing environment, where tasks are performed by remote processing devices.

### Example Cloud Computing Environment

A cloud computing environment includes one or more cloud computing nodes on which computing units may be run, with which the local computing devices may communicate. The cloud computing environment may be a public network, private network, hybrid network or dedicated network. This enables cloud computing environment to offer infrastructure, platforms or software as services, without maintaining resources on any local computing devices.

In a cloud-computing environment, program modules or certain portions may be stored in the remote memory storage device. In a cloud-computing environment, the computer 400 may be connected to a network through the network interface 411, using a modem or even wireless networking via an antenna in some instances, which may be connected to the system bus 412 via the network interface.

The detailed description and drawings are only meant to illustrate how specific embodiments in the disclosure can be practiced and are by no means supposed to be restrictive. Even though the present disclosure has been described in detail, various modifications may be made to these embodiments without departing from the scope of the disclosure. The scope of the embodiments is to be defined by the appended claims, along with the full range of equivalents to which such claims are entitled.

We claim:

1. A method for data-driven dynamic expertise mapping and ranking, wherein the said method comprises a group of nodes including a central node corresponding to an entity and a plurality of nodes corresponding to the expertise validated by the entity, with:
a. expertise being validated via the knowledge showcased by the entity on relevant topics, which are rated based on the crowdsourced data obtained through (1) reviews by peers of similar expertise (2) references from peers in the same industry (3) references from beneficiaries of expertise,
b. Big data analyses of these ratings and generation of a numerical value termed Expertise Quotient using probability ratings that reflects the expertise and professional credibility of the entity,
c. Identification of reliability ratings, trustworthiness ratings and Trust Index for each of the plurality of nodes corresponding to each of the entity and ranking the entities based on Expertise Quotient,
the corresponding data being stored in machine-readable medium, which is utilized to identify the top expertise in preferred domains.

2. The method as claimed in claim 1, wherein showcasing expertise includes responding to relevant topics corresponding to a plurality of nodes by challenging or supporting the perspectives, opinions or insights of experts in the industry.

3. The method as claimed in claim 1, wherein reviewing includes gathering double-blind review ratings on the showcased expertise corresponding to a plurality of nodes on various attributes from peers with similar expertise identified dynamically with a maximum deviation of 10%, averaging the ratings for all the different attributes and multiplying it by the current Expertise Quotient of the peer for that specific expertise.

4. The method as claimed in claim 1, wherein referencing includes gathering references for the entity corresponding to a specific node from peers who are from the same domain and know the entity professionally, averaging the ratings for all the different attributes and multiplying it by the current Expertise Quotient of the referee for that specific expertise.

5. The method as claimed in claim 1, wherein defining includes gathering impact ratings for the entity corresponding to a specific node from people who have been impacted by the expertise of the entity, averaging the ratings for all the different attributes and multiplying it by the current Expertise Quotient of the referee for that specific expertise

6. The method as claimed in claim 1, wherein Expertise Quotient is calculated using Bayesian theorem:
E=[(v÷(v+m))×R]+[(m÷(v+m))×C]
where, E is the Expertise Quotient corresponding to the plurality of nodes; R is the average of all the ratings received for that expertise, including the review ratings, reference ratings and impact ratings; v is the total number of ratings for that expertise, including the review ratings, reference ratings and impact ratings; m is the minimum number of ratings required per expertise, which is a constant; and C is the mean value of all the ratings for that expertise, including the review ratings, reference ratings and impact ratings.

7. The method as claimed in claim 1, wherein ranking includes calculating the percentile ranking on the basis of the Expertise Quotient, corresponding to the plurality of nodes for entities who have validated their expertise and highly rated responses for each expertise are rewarded.

8. The method as claimed in claim 1, wherein the resultant percentile rank of an entity based on Expertise Quotient may be compared against that of others from similar industries or expertise.

9. The method as claimed in claim 1, wherein a reliability rating is identified for each node based on the variance between the review ratings provided by an entity and the average of the review ratings gathered from all the other entities for a specific expertise.

10. The method as claimed in claim 1, wherein a trustworthiness rating is identified for each node based on the variance between the reference ratings provided by an entity and the average of the reference ratings gathered from all the other entities for that specific expertise.

11. The method as claimed in claim 1, wherein a Trust Index is identified for each node by averaging the reliability score and trustworthiness score for an entity corresponding to a node.
